(19) United States
(12) Patent Application Publication
(10) Pub. No.: US 2006/0137383 A1
(43) Pub. Date: Jun. 29, 2006

(54) Inline booster for beverage dispensing system

(75) Inventor: Sam Chiusolo, Port Perry (CA)

Correspondence Address: DIMOCK STRATTON LLP, 20 QUEEN STREET WEST SUITE 3202, BOX 102, TORONTO, ON, M5H 3R3, CA

(73) Assignee: Icefloe Technologies Inc., Mississauga (CA)

(21) Appl. No.: 10/525,052

(22) PCT Filed: Aug. 19, 2003
(86) PCT No.: PCT/CA03/01241

§ 371 Date: Nov. 14, 2005

Related U.S. Application Data
(60) Provisional application No. 60/404,159, filed on Aug. 19, 2002.

(51) Int. Cl. B67D 5/62

(52) U.S. Cl. 62/390; 62/399

(57) ABSTRACT

A beverage distribution system is provided for boosting the cooling capacity of conventional beer dispensing systems. This reduces the tendency of beer to foam prior to the dispensing of same. The beverage distribution system has a container for storing a beverage and a cooler for refrigerating the container and the beverage stored therein. The system also includes a beverage dispensing unit and a distribution line for delivering the beverage from the container to the dispensing unit. A trunk line extends substantially from or near the cooler to or near the dispensing tower. It includes the distribution line and a refrigerant line in an abutting relationship. The system has a heat transfer unit connected to the trunk line which is filled by refrigerant accumulating from the refrigerant line. The heat transfer unit has a coil connected to the distribution line for immersing a portion of the beverage in a bath of the refrigerant. A refrigeration loop circulates refrigerant through the heat transfer unit. Methods for chilling a beverage and reducing the foaming of beer using the beverage distribution system are also provided.

### FIELD OF INVENTION

The invention generally relates to the field of beverage dispensing systems and more particularly to a device for boosting the cooling capacity of an establishment-wide beer dispensing system such as typically found in bars and the like and/or reducing the tendency of the beer to foam.

### BACKGROUND OF INVENTION

Many bars and other such establishments have a beverage dispensing system for dispensing draft beer and other such beverages. Typically, the beer is stored in kegs, which are located in a refrigerated room or walk-in cooler. The kegs are connected to one or more plastic feeder rubes which feed into one or more beer distribution lines, depending on the number of labels or brands being dispensed or the quantity thereof. The beer distribution lines extend from the cooler to the dispensing units (alternatively referred to as “fountains” or “beer towers”). Each beer distribution line may be connected to a downstream feeder system which distributes a label or brand of beer to multiple dispensing units located at the bar.

In addition to the beer distribution lines, one or more cooling lines typically extend along the beer distribution lines from the cooler room to the termination point if the beer distribution lines. These cooling lines are usually placed adjacent to the beer distribution lines, and may sometimes be coiled or spiraled around the beer distribution lines. The cooling lines are intended to keep the beer cool as it is routed from the kegs in the cooler room to the beer dispensing tower(s).

The distance the beer distribution and attendant cooling lines typically cross to reach their termination point from the cooler room can often exceed well over a hundred feet. The lines may pass over heating ducts or hot water lines, or otherwise be subjected to heat loads such as will occur when the lines are routed along the ceiling, where the temperature can be significantly warmer than room temperature. Even room temperature can have an effect on the temperature of the beer distribution and cooling lines, depending on the distance and how crowded or hot the establishment is. Part of the problem arises from the fact that the heat transfer characteristics between the cooling lines and the beer distribution lines is not particularly good, given that plastic tubing is typically used for both she beer distribution lines and cooling lines in order to reduce piping costs. The problem is further compounded in that the downstream beer feeder system, which may not be cooled, can itself be quite long and expose the beer to unwanted heat.

The rise in the temperature of the beer at the point of dispensation can be significant. The kegs are typically kept at a temperature of about 38 degrees Fahrenheit (all temperatures are quoted in Fahrenheit) since other types of products, such as fresh vegetables, are often also stored in the cooler room. This typically limits the operating temperature of the cooler room so as to prevent such items from freezing. Due to the factors enumerated above, the temperature of the beer can rise about 6 to 10 degrees at the point it is poured from the dispensing towers(s).

Warm beer is undesirable for a number of reasons. First, consumers generally prefer colder beer over warmer beer. Second, warm beer tends to froth or foam when it is being poured, which increases pouring times. In addition, the foam is generally wasted by the bartender, i.e., beer is typically poured so that the foam overflows the mug, which can sometimes lead to a messy environment. Colder beer would provide less waste, less mess, and is more consumer friendly. At the very lest, it is desirable to minimize foaming even if the temperature of the beer at the point of dispensation cannot be substantially reduced.

### SUMMARY OF INVENTION

According to one aspect of the invention a beverage distribution system is provided. The system includes a beverage source; at least one beverage dispensing unit; at least one distribution line for delivering beverage from the beverage source to the dispensing unit; and a heat transfer unit located distally from the beverage source for immersing at least a portion of the distribution line in a refrigerant bath. The heat transfer unit counteracts the warming of the beverage, such as beer, that arises as a result of routing the beverage distribution lines over long distances or through warm environments.

According to another aspect of the invention, a heat transfer unit is provided. The unit includes a housing which defines a volume. A first inlet tube is provided for introducing refrigerant into the housing and a first outlet tube provides for egress of the refrigerant. The first inlet and first outlet tubes are disconnected within the housing in order to allow refrigerant to accumulate in the volume. A second tube disposed in the housing includes an inlet and outlet situated exterior of the housing. The second tube is continuous through the volume so as to isolate the contents therein from the refrigerant in the housing. The heat transfer unit is particularly suited for retrofitting a beverage distribution system in which a beverage source is located distally from a beverage dispensing unit and delivered thereto via a beverage distribution line.

According to another aspect of the inventions a method is provided for chilling a beverage in a beverage distribution system in which a beverage source is located distally from a beverage dispensing unit and delivered thereto via a beverage distribution line. The method includes installing a heat transfer unit as described above nearer to the dispensing unit than the beverage source; splicing the beverage distribution line to the inlet and outlet of the second tube; and splicing a heat exchange loop to the first inlet and outlet, wherein the heat exchange loop circulates refrigerant through a heat exchanger, thereby circulating refrigerant through the heat transfer unit.

According to another aspect of the invention, a method for reducing foaming of beer in a beer distribution system is provided. In the beer distribution system a keg is located distally from a dispensing tower and the beer is delivered thereto under pressure via a beer distribution conduit. The method includes cooling the keg and pressurizing the bulk of the beer distribution line to at least 36 psi; and more preferably to 50-58 psi. The diameter or diameters of the conduit is sized such that a beer flow rate of about 1-2, and more preferably about 1.3-1.5 ounces per second is achieved at the dispensing tower.

### BRIEF DESCRIPTION OF DRAWINGS

The foregoing and other aspects of the invention are described in greater detail in the accompanying drawings which illustrate the principles of the invention and are not intended to be limiting.

In the drawings:

FIG. 1 is a schematic system diagram of a beer distribution system according to the preferred embodiment;

FIG. 2 is a cross-sectional diagram of an inline booster which can be retrofitted to an existing in order to increase the efficacy of the beer cooling; and

FIG. 3 is a cross-sectional diagram of a modified version of the booster shown in FIG. 2.

### DETAILED DESCRIPTION OF ILLUSTRATIVE EMBODIMENTS

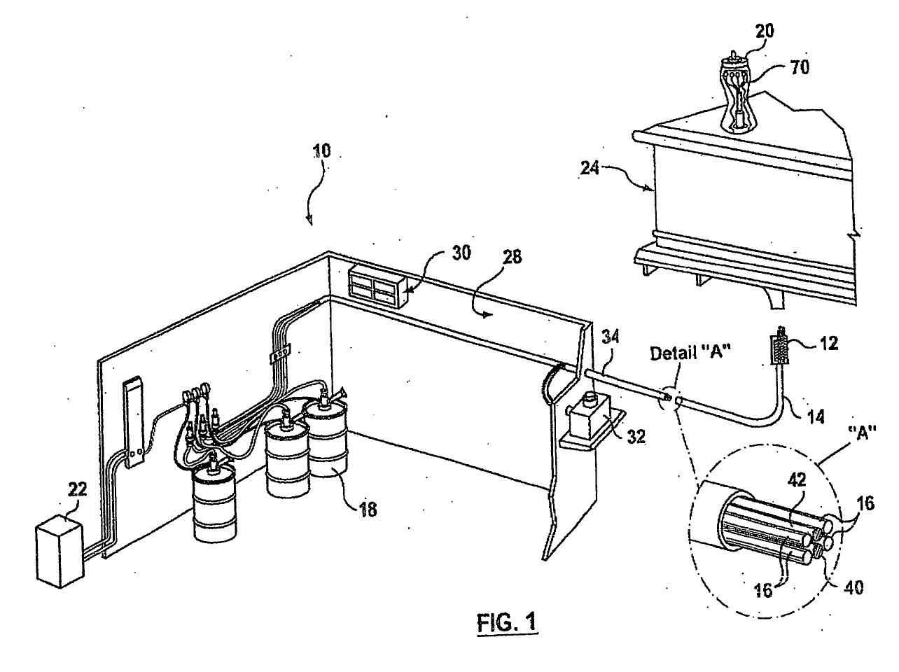

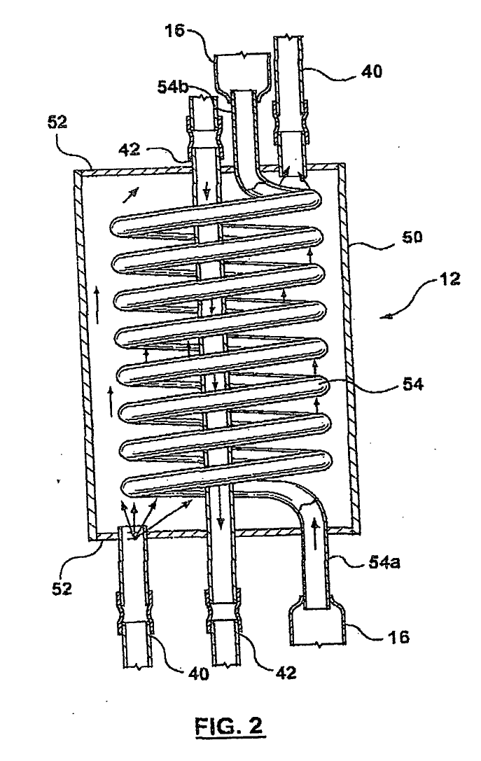

FIG. 1 shows a beer distribution system 10 including an inline booster unit 12 which can be retrofitted to an existing beer distribution application. The inline booster 12 is shown in isolation in FIG. 2.

As seen in FIG. 1, the beer distribution system 10 includes a trunk line 14 comprising one or more beer distribution lines 16 which extend from one or more kegs 18 to one or more dispensing towers 20. The beer distribution lines 16 are pressurized by an air pressure source 22 which provides the motive force for delivering the beer from the kegs 18 to the dispensing towers 20. The illustrated embodiment shows one dispensing tower located at a main bar 24, but in practice the trunk line can be spliced to service additional bars.

The distribution system 10 includes a main cooling system 30 used to refrigerate the kegs 18 in a walk-in cooler 28 and a secondary cooling system 34 used to cool the beer distribution lines 16. The secondary cooling system includes a pump and a heat exchanger 32, which are combined in a power pack. The refrigerant is preferably a 30/70 glycol/water mixture, or alternatively any other useful coolant such as water, which is pumped through a refrigerant supply line 40 to the dispensing tower 20 and returned therefrom via a refrigerant return line 42. The beer distribution lines 16 surround the refrigerant supply and return lines 40 & 42 and the bundle is encased in insulating and moisture-proofing materials to form the trunk line 14.

Despite such precautions, due to the typical length of the trunk lines 14, the beer carried thereby often warms up by a few degrees by the time it is dispensed from the dispensing towers 20. In order to limit or reduce the heat gain, it is preferred to install one or more booster units 12 as near as possible to the point of dispensation.

The booster unit 12 can be retrofitted to a pre-installed beer distribution system as discussed above or installed upon its initial construction. As shown in FIG. 2, the preferred booster unit 12 comprises a housing 50 constructed from a stainless steel sleeve sealed at both ends by stainless steel plates 52 defining a volume of about one to one-and-half liters. Within this volume there are one or more coils of stainless steel, beer-carrying tubings 54. For the purpose of illustration, only one such coil 54 is shown, it being understood that there may be as many beer-carrying coils as there are beer distribution lines in the trunk line. The coil 54 includes integral inlet and outlet tubes 54a, 54b which pierce the end plates to allow for ingress and egress of the beer to/from the beer distribution line 16. The inlet and outlet tubes 54a, 54b can be welded to the end plates 52 or a compression fitting (not shown) can be used to seal the tubing. The plastic tubing forming the beer distribution line 16 can be coupled to the inlet and outlet tubes 54a, 54b using techniques well know on the art. In the illustrated embodiment the plastic tubing forming the beer distribution line 16 preferably has a diameter of ⅜^{th} inch, and the beer-carrying coil 54 is a ¼ inch tube having a length ranging from about twenty to 50 feet, with approximately 35 feet being preferred. The beer carrying coil 54 thus provides a constricted passage for the flow of beer therethrough, the benefits of which are discussed in greater detail below.

Alternatively other diameters and lengths of tubing can be employed and other geometries other than a spiral shape can be used to route beer-carrying piping through the sleeve, where the piping has a length greater than the length, height or width of the sleeve 50.

In the embodiment shown in FIG. 2, the refrigerant from the refrigerant supply line 40 enters the booster 12 at one end, fills the sleeve 50, then exits the opposite end of the booster. The refrigerant is continuously circulated through the booster 12 by the pump (power pack) 32, flowing so the dispensing tower 20 as shown in Fig., and returning to the power pack 32 via the refrigerant return line 42 which, as shown in FIG. 2, is routed through the booster 12. In the preferred embodiment the power pack 32 cools the glycol/water refrigerant to about 32 degrees and pumps it through the sleeve 50 at a rate of about 25 to 170 gallons per hour, with 125 gallons per hour being preferred. The booster 12 permits the dispensed beer to be immersed in a cooling bath of refrigerant for a relatively extended period of time under conditions which allow for efficient heat transfer. With a glycol flow rate of 125 gal/hr, it is anticipated that for a single 35 foot stainless steel coil within the sleeve 50 the temperature of the beer therein will drop from about 18 to 26 degrees at a constant pour rate. The temperature drop will vary depending on the cooling capacity of the power pack 32, flow rate of the refrigerant, the distance between the porter pack 32 and the booster 12, the quantity of beer being cooled, and the number of beer-carrying coils 54 in the booster. These parameters should ideally be managed so that the glycol/water refrigerant is maintained at approximately 28-34° F.

In the event beer sits in the sleeve 50 between pours, it will continue to drop in temperature but will never drop below the temperature of the refrigerant. For this reason it is preferred to prevent the refrigerant from dropping below the freezing point of the beer, which is about 28° F. It is also preferred to insulate the booster 12 to prevent it from sweating and to minimize heat gain from the ambient environment.

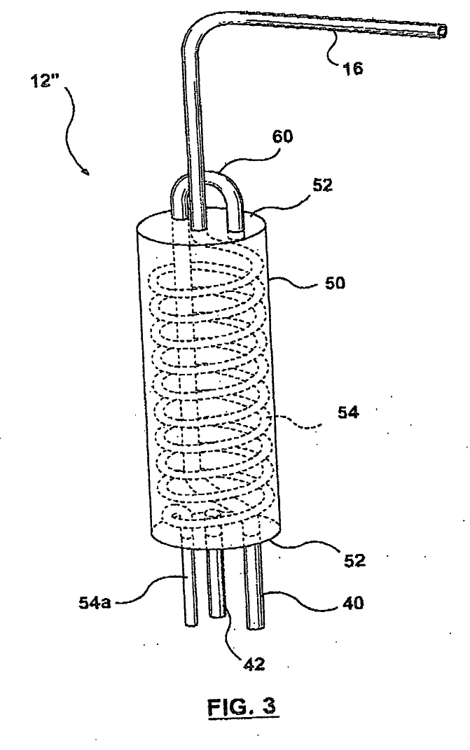

FIG. 3 shows an alternative embodiment 12′ of the booster in which the refrigerant supply line 40 does not extend to the dispensing tower 20 but terminates at the booster. In this embodiment, the refrigerant enters the booster 12′ at its downstream end (opposite to that shown in FIG. 2) via a U-shaped section 60 and flows through the booster to the power pack via the refrigerant return line 42.

In FIGS. 2 and 3, either the refrigerant return line 42 or the refrigerant supply line 40 have been routed through the booster 12. However, in alternative embodiments at least one of these lines can be routed external of the booster.

It should also be appreciated that the booster unit 12, 12′ can be applied in a non-retrofit application. This may occur, for instance, where the secondary cooling system employs freon for the refrigerant, which makes it difficult to splice into an existing system. In this case the refrigerant inlet and outlet stubs of the booster unit can be connected to another cooling medium or refrigerant.

For example, a pump can be submerged into an ice/water bath to pump ice-cold water through the booster unit. This will have the same results on the beer temperature. After the water passes through the booster, the ice cold water can be used to maintain the temperature of the beer by traveling through a ⅜ inch copper line all the way up to the dispensing tower, then returning to the ice bath. The flow rate and refrigeration capacity should be such as to maintain the water in the booster unit at about 32-34° F.

Use of the booster unit is likely to improve the prospect of the beer being dispensed at an ice-cold temperature even if the cooler 28 where the legs 18 are stored is not working to maximum efficiency, and/or when the beer distribution lines 16 have to travel a considerable distance to the point of dispensation, passing near beating ducts or hot water pipes. When the temperature of the beer is brought down to the 32° F. range, any foaming problems that may exist will also be minimized. This provides an economic benefit by not wasting beer to foam and by giving the customer a better product.

Moreover, the preferred embodiment is useful even in situations where the refrigerant is warmed to such an extent that no meaningful cooling of the beer can be achieved, as may occur when the distribution runs are particularly long or the power pack is not working to maximum efficiency. In the preferred embodiment, as mentioned above, the beer distribution lines are ⅜^{th} inch conduits which are reduced to ¼ inch conduits for a considerable distance (i.e, the length of the coil 54, range from about twenty to fifty feet). Furthermore, within or adjacent to the dispensing tower 20 the beer distribution line 16 is preferably further restricted to a 1/16 inch conduit for a few feet, as shown by tubing 70 in FIG. 1. These narrower, constricted conduits help to reduce turbulence in the beer flow, which assists to reduce foaming problems.

In addition, the constriction introduced by the booster unit, particularly in a retrofit application, results in lower beer flow rates at the dispensing tower. In order to maintain the same flow rate that exists in a system without the booster, the pressure provided by the air pressure source must be raised considerably. For example, using a ⅜ inch conduit, the air pressure source is typically operated at about 20-5 psi. Introduction o the preferred booster unit requires the air pressure source to be operated at about 50-58 psi. When the system is operated at a higher pressure, the carbon dioxide and other gases entrained in the beer flow are more readily soluable, thus reducing the tendency to foam. Note that merely increasing the pressure in the beer distribution lines is insufficient to achieving reduced foaming. This is because increasing the pressure to 50 psi in a ⅜″ distribution system, for example, would result in such as fast flow at the dispensing tower that excess foaming would occur. However, by increasing the pressure over the majority of the beer distribution lines and maintaining the same flow rate, about 1-2 ounces per second, and more preferably about 1.3-1.5 ounces per second, foaming problems can be significantly controlled.

Note that in this aspect of the invention, an isolated piece of constricted conduit (i.e., in alternative to the booster unit) as short as two to three feet connected or spliced near the dispensing tower may introduce sufficient resistance so as to require a pressure of about 50-58 psi in the majority of the beer distribution line, in order to achieve a flow rate of about 1.3-1.5 ounces per second. The constricted conduit or tubing need not be precisely ¼ or 1/16 inch, since other conduit sizes or lengths will suffice. Rather, the important parameter appears to be increasing the pressure in the beer distribution lines to at least 36 psi with the size and length of the constricted conduit being selected so as to yield the desired flow rate of about 1-2 ounces per second, and more preferably about 1.3-1.5 ounces per second.

While the preferred embodiment has related to a beer distribution system, it will be understood that the booster can be applied to other types of beverage distribution systems. Similarly, those skilled in the art will appreciate that numerous modifications may be made to the embodiments described herein without departing from the spirit of the invention.

1. A beverage distribution system, comprising:
a) a container for storing a beverage;
b) a cooler for refrigerating the container and the beverage stored therein;
c) at least one beverage dispensing unit;
d) at least one distribution line for delivering the beverage from the container to the dispensing unit;
e) a trunk line extending substantially from or near the cooler to or near the dispensing tower, the trunk line including the distribution line and at least one refrigerant line in an abutting relationship;
f) a heat transfer unit located distally from the cooler and connected to the trunk line, the heat transfer unit defining a volume which is filled by refrigerant accumulating from the refrigerant line, the heat transfer unit having a coil connected to the distribution line for immersing a portion of the beverage in a bath of the refrigerant; and
g) a refrigeration loop, including the refrigerant line, for circulating refrigerant through the heat transfer unit.

2. The system according to claim 1, including air pressure means for motivating the beverage to flow through the distribution line.

3. The system according to claim 1, wherein the distribution lines are pressurized.

4. The system according to claim 1, wherein the heat transfer unit is physically located nearer to the dispensing unit than the beverage container.

5. The system according to claim 1, wherein the length of the coil exceeds the length, width or height of the heat transfer unit.

6. The system according to Claim 5, wherein the coil is constructed from a metal.

7. The system according to claim 1, wherein the refrigerant loop includes a pump and a heat exchanger for circulating refrigerant through the heat transfer unit and for cooling the refrigerant.

8. The system according to claim 1, wherein the beverage is beer.

9. The system according to claim 1, wherein the coil is metallic, has a length of approximately twenty to fifty feet, and the flow rate of the refrigerant through the heat transfer unit is approximately 25 to 125 gallons per hour.

10. A heat transfer unit, comprising:
a) a housing, defining a volume;
b) a first inlet tube for introducing refrigerant into the housing and a first outlet tube for egress of the refrigerant, the first inlet and first outlet tubes being disconnected within the housing in order to allow refrigerant to accumulate in the volume; and
c) a second tube disposed in the housing having an inlet and outlet situated exterior of the housing, the second tube being continuous through the volume so as to isolate the contents therein from the refrigerant in the housing.

11. The device according to claim 10, wherein the second tube s a metallic coil.

12. The device according to claim 11, including a pump for circulating refrigerant through the housing and a heat exchange for cooling the refrigerant.

13. A method for chilling a beverage in a beverage distribution system in which a beverage container is located distally from a beverage dispensing unit and the beverage delivered thereto via a pressurized beverage distribution line, the method comprising:
a) cooling the container;
b) cooling the beverage distribution line;
c) installing a heat transfer unit nearer to the dispensing unit than the container, wherein the heat transfer unit comprises:
i) a housing, defining a volume;
ii) a first inlet tube for introducing refrigerant into the housing and a first outlet tube for egress of the refrigerant, the first inlet and outlet tubes being disconnected within the housing in order to allow refrigerant to accumulate in the volume;
iii) a second tube disposed in the housing having an inlet and outlet situated exterior of the housing, the second tube being continuous through the volume so as to isolate the contents therein from the refrigerant in the housing;
d) splicing the beverage distribution line to the inlet and outlet of the second tube;
e) splicing the first inlet and first outlet to a refrigeration loop, wherein the loop circulates refrigerant through a heat exchanger, thereby circulating refrigerant through the heat transfer unit.

14. A method for reducing foaming of beer in a beer distribution system in which a keg is located distally from a dispensing tower and the beer delivered thereto under pressure via a beer distribution conduit, the method comprising:
a) cooling the keg;
b) pressurizing the bulk of the beer distribution line to at least 36 psi; and
c) selecting conduit having one or more diameters such that a beer flow rate of about one to two ounces per second is achieved at the dispensing tower.

15. The method according to claim 14, including cooling the beer in the beer distribution lines.

16. The method according to claim 14, wherein the bulk of the beer distribution line is pressurized in the range of about 50-58 psi.
